(19) United States
(12) Patent Application Publication
(10) Pub. No.: US 2026/0332419 A1
(43) Pub. Date: Oct. 22, 2026

(54) SYSTEMS AND METHODS FOR ENCRYPTED LOGIN TO BARE METAL

(71) Applicant: CenturyLink Intellectual Property LLC, Denver, CO (US)

(72) Inventor: Thomas HOLKENBRINK, Ferndale, WA (US)

(73) Assignee: CenturyLink Intellectual Property LLC, Denver, CO (US)

(21) Appl. No.: 19/443,388

(22) Filed: Jan. 8, 2026

Related U.S. Application Data
(60) Provisional application No. 63/749,392, filed on Jan. 24, 2025.

(51) Int. Cl. H04L 9/32; G06F 21/62; H04L 9/08; H04L 9/30

(52) U.S. Cl. CPC H04L 9/3228; G06F 21/6254; H04L 9/0825; H04L 9/0863; H04L 9/0869; H04L 9/30; H04L 9/3213; H04L 9/3236

(57) ABSTRACT

Disclosed are systems and methods for secure password compilation and transmission during bare metal service provisioning. The disclosure enables encrypted password management for Windows image deployment while maintaining necessary cleartext accessibility in system memory. During provisioning, the password is transmitted in encrypted form across the network, enhancing security during data transfer. Upon reaching the target system, the password is securely decrypted and stored in system memory, allowing authorized user authentication without compromising security. This method eliminates the vulnerability of cleartext password transmission while preserving Windows authentication functionality. The disclosure enables secure password handling throughout the provisioning process while maintaining compatibility with existing Windows authentication mechanisms.

### CROSS-REFERENCE TO RELATED APPLICATIONS

This application claims the benefit of priority from U.S. Provisional Application No. 63/749,392, filed Jan. 24, 2025, which is incorporated herein by reference in its entirety.

### FIELD OF THE DISCLOSURE

The present disclosure relates to a computerized framework for secure login mechanisms to network and local resources and devices.

### SUMMARY OF THE DISCLOSURE

According to some embodiments, as discussed herein, the disclosed systems and methods provide a computerized framework configured to address a critical security vulnerability in Windows® system provisioning by implementing a novel methodology for secure password handling during cloud deployment. Specifically, the disclosed framework resolves the longstanding issue where Windows passwords must be transmitted in cleartext during system provisioning—a significant security concern, particularly in enterprise and government deployments where sensitive systems may span multiple geographic locations. This vulnerability has been a known defect in Cloud Config implementations, where Linux systems can utilize MD5 hashing but Windows deployments lack a standardized cross-platform hashing methodology.

In some embodiments, the framework can leverage a multi-part configuration approach that separates the user creation process from password assignment, utilizing Cloud Config's sectioning capabilities. In the initial section, the framework creates user accounts and assigns group memberships without setting passwords, eliminating the cleartext password requirement in the traditional workflow. Subsequently, as discussed infra, the framework can implement an encryption mechanism that generates and manages secure passwords using a combination of temporal and hardware-specific parameters. This separation of concerns allows for enhanced security while maintaining compatibility with existing deployment infrastructures.

In some embodiments, the framework can generate unique encryption keys through a novel combination of temporal and hardware identifiers. The primary key generation mechanism combines two distinct elements: the epoch timestamp at the exact moment of provisioning and the unique MAC address of the target system. This temporal-hardware hybrid approach ensures cryptographic uniqueness even in scenarios of simultaneous deployments, as the hardware-specific component (MAC address) provides guaranteed differentiation. The epoch timestamp adds an additional layer of uniqueness and temporal tracking, making the encryption key both unique to the specific deployment instance and traceable to a specific point in time.

In some embodiments, the framework can implement key derivation processes that begins with the concatenation of the epoch timestamp and MAC address. This combined value serves as the initial seed for the key generation process. The framework then applies a series of transformations to this seed value, including multiple rounds of hashing and the application of a predefined salt value. The salt, while technically public, is obfuscated within the implementation to prevent trivial analysis of the key derivation process. The resulting key serves as the basis for all subsequent encryption operations within the deployment process.

In some embodiments, the framework can utilize an advanced encryption process that employs a 256-bit public key system with 48,000 iterations of padding. This approach ensures that even minimal password inputs are substantially expanded before encryption, effectively normalizing the encrypted output regardless of the input length. The padding process is designed to maintain consistent security levels across varying password complexities while ensuring that the final encrypted value can be reliably transmitted and stored within existing infrastructure systems. The framework then compresses these expanded values into either 512-bit or 256-bit hashes, depending on deployment requirements and compatibility needs.

In some embodiments, the framework can implement a token generation system that creates encrypted password tokens using the derived encryption key. These tokens encapsulate the actual password value while maintaining the security properties established by the key generation process. The token generation process includes multiple stages of transformation and validation to ensure that the resulting token can be reliably decrypted only with the specifically generated key for that deployment instance. This approach effectively creates a one-time-use encryption channel for each deployment, as the temporal component of the key ensures that subsequent deployments will use different encryption parameters.

In some embodiments, the framework can manage token lifetime and validity through its temporal key component. Since the encryption key includes the epoch timestamp of the deployment, tokens generated during the provisioning process have an implicit temporal context. This allows for potential implementation of token expiration and validation mechanisms, though the primary implementation focuses on the immediate deployment process. The framework can be extended to include explicit token lifetime management for scenarios requiring enhanced security controls.

In some embodiments, the framework can integrate with existing Windows system management tools by implementing a staged execution process that maintains security throughout the deployment lifecycle. After the initial user creation phase, it executes a series of commands through native Windows interfaces (such as ‘net user’) to apply the decrypted passwords. This integration preserves compatibility with standard Windows authentication systems while adding the security layer during the provisioning process. The framework ensures that decrypted passwords are only held in memory during the actual password setting operation, minimizing exposure of sensitive data.

In some embodiments, the framework can extend beyond basic password management to address other limitations in current cloud provisioning systems through its modular architecture. For instance, it enables multi-network configuration capabilities that transcend the traditional single-network limitations of Cloud Config and cloud-init systems. This can be accomplished through the framework's modular approach, which allows for the execution of multiple configuration scripts in different languages (Python, PowerShell, and standard Cloud Config), each optimized for specific tasks while maintaining the security properties established by the key and token management systems.

In some embodiments, the framework can implement obfuscation mechanisms to protect the salt values and encryption mechanisms while maintaining the security properties of the underlying cryptographic operations. This includes methods to obscure the implementation details while maintaining full functionality, ensuring that even if the configuration files are exposed, the core security mechanisms remain protected. The obfuscation extends to both the encryption and decryption functions, though these can be separated for different use cases. The obfuscation process includes multiple layers of code transformation and data encoding, making static analysis of the implementation significantly more challenging while preserving the ability to execute the required cryptographic operations.

In some embodiments, the framework can modify the standard Windows Out-of-Box Experience (OOBE) by preemptively configuring user accounts and removing default administrator accounts, all while maintaining the security properties established by the encryption system. This ensures that systems are immediately secure upon first boot, eliminating the traditional unsecured setup period. The framework accomplishes this by executing its configuration steps before the standard Windows initialization process, effectively bypassing the traditional user setup workflow while ensuring that all credential data remains protected throughout the process.

In some embodiments, the framework can operate in hybrid environments, supporting both Windows and Linux systems through its modular approach to key and token management. While the core innovation addresses Windows-specific password handling, the architecture allows for parallel implementation in Linux environments, maintaining consistent security practices across heterogeneous deployments. The framework's design permits the generation of appropriate configuration files for each operating system while maintaining a unified security model based on the temporal-hardware key generation mechanism.

In some embodiments, the framework can integrate with existing cloud provisioning tools, particularly Cloud-base Init, offering potential licensing opportunities while maintaining the security of the key generation and token management systems. The modular nature of the implementation allows for the encryption mechanism to be separated from the broader configuration management system, enabling third-party integration through a public key infrastructure where deployment systems could incorporate their own public keys and receive encrypted passwords using the framework's methodology. This integration capability extends to both the key generation process and the token management system, allowing for flexible deployment scenarios while maintaining security.

In some embodiments, the framework can utilize multiple scripting languages and technologies (Python, PowerShell, Cloud Config) in a coordinated manner, selecting the most appropriate tool for each specific task while ensuring that the security properties of the key and token management systems remain consistent. This multi-language approach enables optimal performance and compatibility while ensuring that security measures remain consistent across all components of the system. The framework maintains the integrity of the encryption keys and tokens regardless of the specific technology being used for any particular operation, ensuring consistent security properties throughout the deployment process.

According to some embodiments, a method is disclosed for secure login mechanisms to network and local resources and devices. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for secure login mechanisms to network and local resources and devices.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIGS. 3A-3D illustrate exemplary workflows according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

As discussed herein, in some embodiments the framework can implement secure data sharing beyond passwords (e.g., encrypted file contents) to be decrypted upon deployment (e.g., links, account information, and the like). The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. By way of background, managing Windows passwords securely in a cloud-init environment presents multiple challenges, primarily due to the requirement for clear-text password transmission. The disclosed framework provides mechanisms to facilitate secure password handling by implementing encryption, structured decryption mechanisms, and ensuring proper execution order within the cloud-init lifecycle. Accordingly, as discussed herein, by leveraging such functionalities, the disclosed framework can function to encrypt passwords before transmission, securely decrypt them on the system, and integrate them into user accounts while preventing exposure of sensitive data.

Windows passwords typically must be transmitted in cleartext, which introduces significant security concerns. While Linux systems allow passwords to be stored in a hashed format, Windows lacks this capability within cloud-init. The set-passwords module, which works effectively in Linux environments, is ineffective on Windows, creating a gap in security. Furthermore, MaaS (Metal as a Service) does not provide native support for setting passwords, adding another layer of complexity. To mitigate these issues, encryption techniques must be used to secure password data during transmission and storage, followed by controlled decryption on the target system.

To securely handle passwords, the disclosed framework employs Fernet encryption, which is part of the Python cryptography library. Fernet encryption is chosen due to its strong security properties and ease of implementation. Additionally, PBKDF2 HMAC (pseudo random function/hash-based message authentication code) (and/or a similar function, for example) can be used for key derivation, ensuring that passwords are resistant to brute-force attacks. The encryption process involves encoding passwords using a public key and securely transmitting them as part of cloud-init configurations. These encrypted passwords can then be decrypted on the target system using a predefined decryption key.

For example, in practice, encryption can be performed using a Python script that derives a key from a user-specific salt and secret key. The derived key is then used to encrypt or decrypt passwords as needed. The decryption process on the system follows the same approach, ensuring that passwords can be securely restored to their original form without exposing them in transit. Below is an example implementation of this process in Python:
from cryptography.hazmat.primitives.kdf.pbkdf2 import PBKDF2HMAC
from cryptography.hazmat.primitives import hashes
from cryptography.fernet import Fernet
import base64

```
def derive_key(secret_key, salt):
  kdf = PBKDF2HMAC(
    algorithm=hashes.SHA256( ),
    length=32,
    salt=base64.b64decode(salt),
    iterations=480000
  )
  return base64.urlsafe_b64encode(kdf.derive(secret_key.encode( )))
def decrypt_password(secret_message, secret_key, salt):
  key = derive_key(secret_key, salt)
  f = Fernet(key)
  return f.decrypt(secret_message.encode( )).decode( )
```

By implementing this encryption approach, passwords can be transmitted in a secure, obfuscated manner, reducing the risk of exposure. The passwords are enclosed within a specific format known as PENC( ), which includes the encrypted password string. The decryption process relies on a MAC address and provisioned timestamp, ensuring that decryption is restricted to the intended system.

Cloud-init supports multipart configurations, which can be leveraged to structure password management securely. These multipart configurations allow for the separation of different execution stages, ensuring that passwords are processed securely. The first part of the configuration focuses on user account creation and hostname assignment, while subsequent parts handle decryption and password application. This separation ensures that passwords are set only after the necessary system configurations are in place.

A YAML-based cloud-config file can be used to define user accounts. These accounts are initially created with placeholders for passwords, which are later set using the decryption script. Below is an example cloud-config snippet that illustrates how users are defined:

users:
name: tina.primarygal
gecos: ‘Tina Primary User’
primary_group: Administrators
groups: Administrators
inactive: False
name: brian.someguy
gecos: ‘Brian SomeGuy’
primary_group: Users
groups: Users
inactive: False

The password decryption and application process is managed by an embedded Python script within the cloud-init configuration. This script extracts encrypted password data, decrypts it, and assigns it to the respective users. The decryption process ensures that passwords remain protected until they are explicitly needed. The following script outlines how this decryption is performed on the system:

```
from LumenCipher import decrypt_password
def set_user_passwords(users_array):
  for user in users_array:
    decrypted_password = decrypt_password(user[‘Token’], user[‘TokenKey’], ‘EA0wF...’)
    print(f”Setting password for {user[‘UserName']}”)
users_array = [
  {‘UserName’: ‘tina.primarygal’, ‘Token’: ‘gAAAAABnd...’, ‘TokenKey’:
‘00:00:00:00:00:00_2025010216’},
  {‘UserName’: ‘brian.someguy’, ‘Token’: ‘gAAAAABnd...’, ‘TokenKey’:
‘00:00:00:00:00:00_2025010216’}
]
set_user_passwords(users_array)
```

To further enhance security, a PowerShell script can be used to remove password-related tokens from log files once they have been applied. This ensures that no residual sensitive data is left behind in system logs. The script iterates through all users and replaces their tokens with placeholders, effectively obfuscating any trace of the original passwords:

```
ForEach ($user in $usersArray) {
  (Get-Content ‘C:\Program Files\Cloudbase Solutions\Cloudbase-Init\log\cloudbase-init.log’) \
    -replace [regex]::escape($user.Token),’<LOCAL-USER-TOKEN>‘ | \
    Set-Content ‘C:\Program Files\Cloudbase Solutions\Cloudbase-Init\log\cloudbase-init.log’
  if($user.TokenKey){
    (Get-Content ‘C:\Program Files\Cloudbase Solutions\Cloudbase-Init\log\cloudbase-init.log’)
\
      -replace [regex]::escape($user.TokenKey),’<LOCAL-USER-KEY>‘ | \
      Set-Content ‘C:\Program Files\Cloudbase Solutions\Cloudbase-Init\log\cloudbase-
init.log’
  }
}
```

Accordingly, as provided herein, the disclosed framework provides a structured approach to handling Windows passwords securely by implementing encryption before transmission, structured decryption upon arrival, and controlled execution using multipart configurations. This disclosed method ensures that passwords are never exposed in cleartext, reducing the risk of compromise. Additionally, by leveraging secure storage mechanisms and log sanitization techniques, the risk of password leakage is further minimized. With this implementation, administrators can confidently manage Windows passwords within cloud-init environments while maintaining a high level of security.

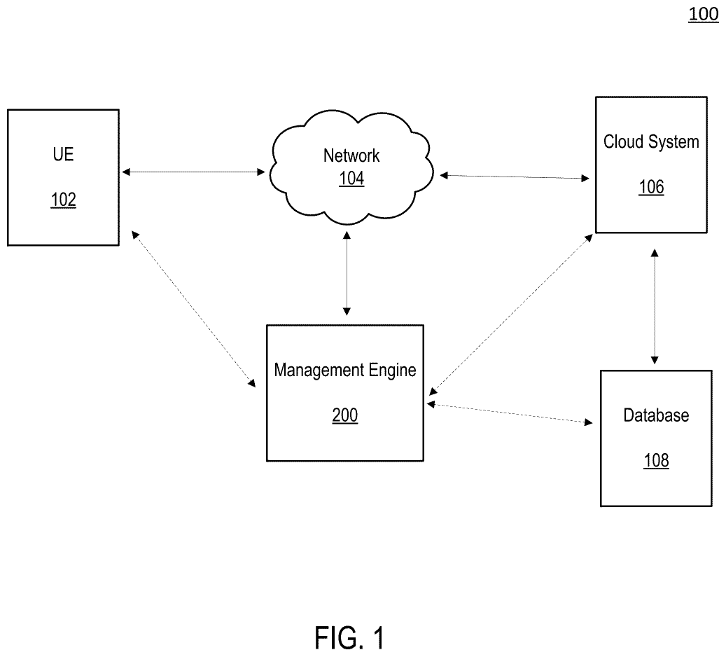

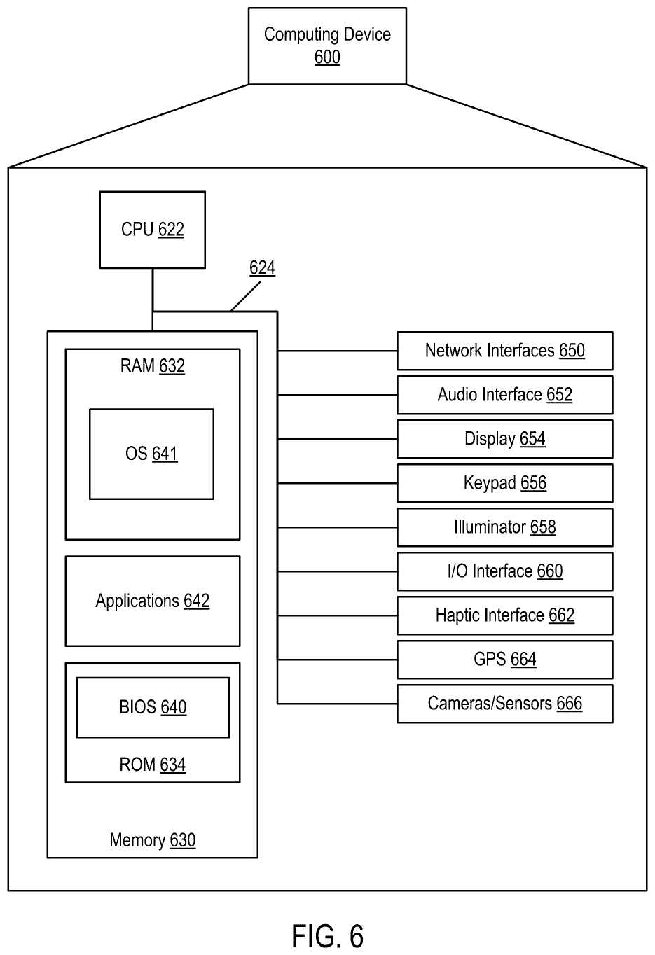

With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network platform (e.g., Lumen® Technologies, for example), which has associated network resources hosted on the internet or private network (e.g., network 104), which enables (via engine 200) the functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

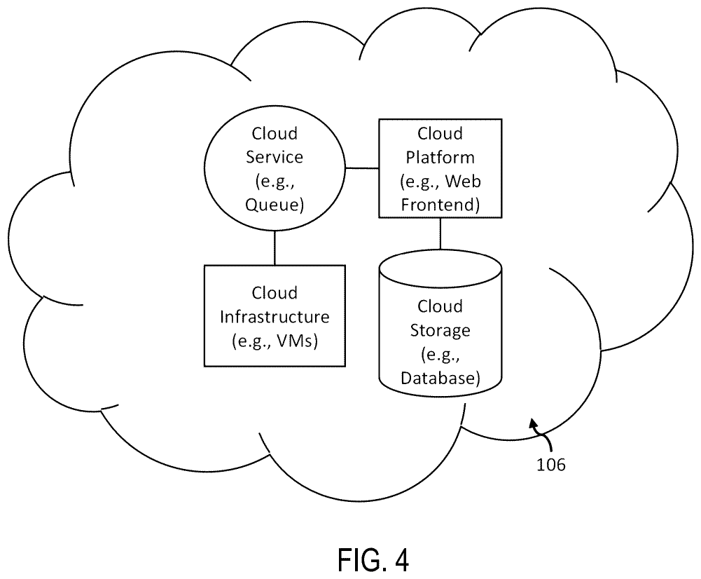

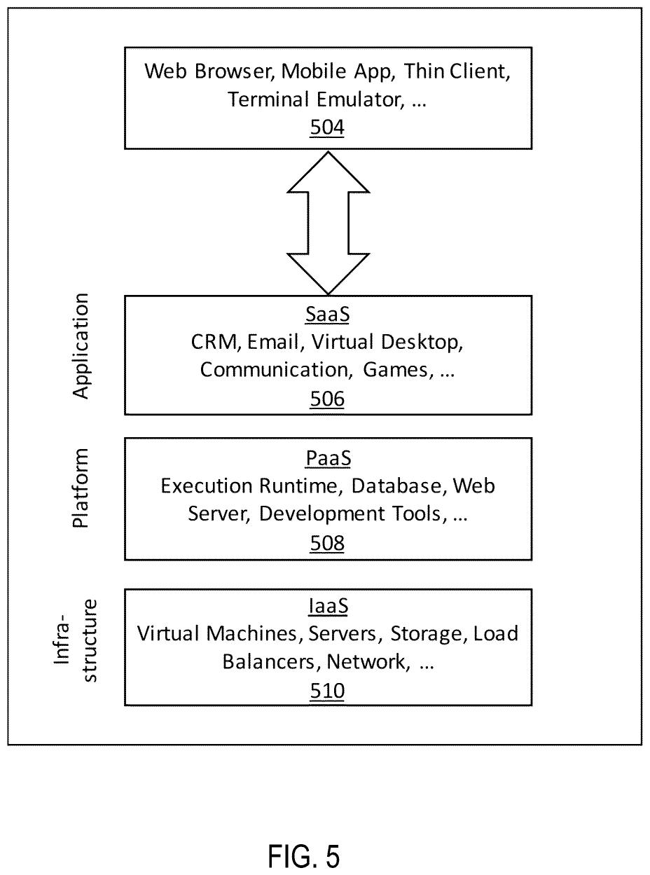

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: network as a service (NaaS) 510, platform as a service (PaaS) 508, and/or software as a service (SaaS) 506 using a web browser, mobile app, thin client, terminal emulator or other endpoint 504. In some embodiments, as understood by those of skill in the art, an infrastructure as a service (IaaS) can be implemented—for example, as part of and/or in addition to SaaS 506, PaaS 508 and/or NaaS 510 (and/or MaaS, as per above). FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below.

According to some embodiments, as discussed above, management engine 200 may function as an application provided by cloud system 106. In some embodiments, engine 200 may function as an application installed on a server(s), network location, database 108, and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102 and/or in connection with database 108.

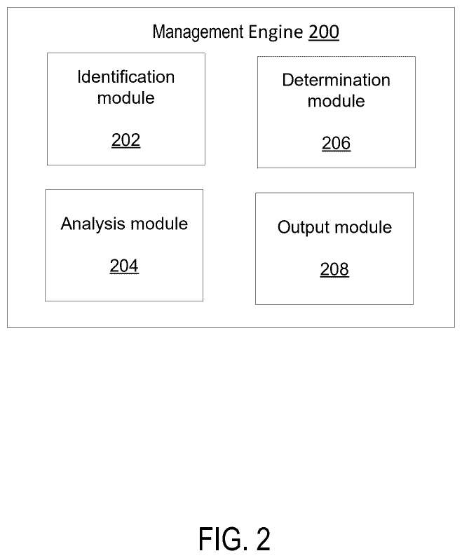

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Management engine 200 or other device(s) running Process 300 may be operated entirely at the device level, or with cloud support as a distributed system, or at a service provider's infrastructure, as non-limiting implementation examples. It will be understood that the disclosure herein provides for a configuration that is platform agnostic and may be operated on multiple alternative platforms as a matter of design choice using the teachings described.

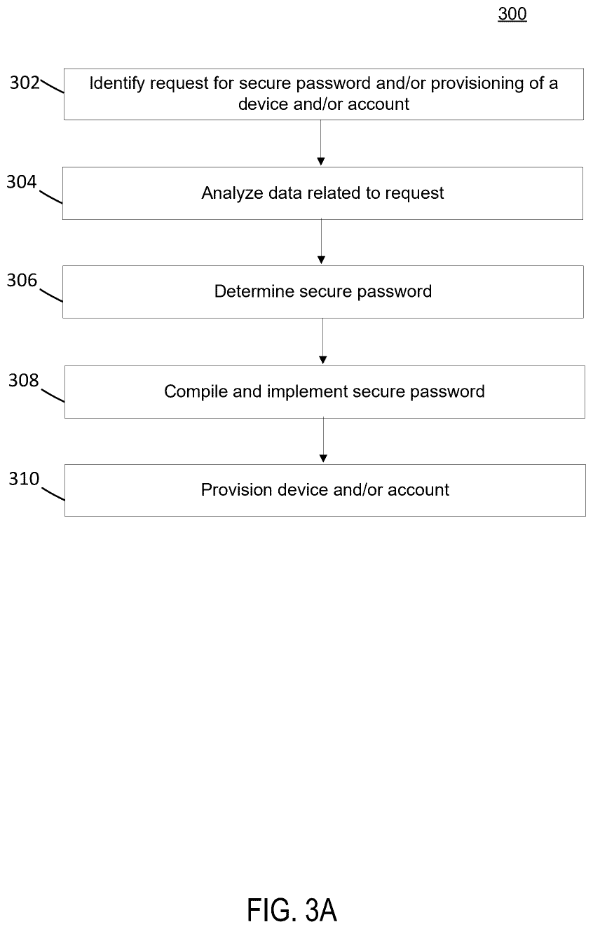

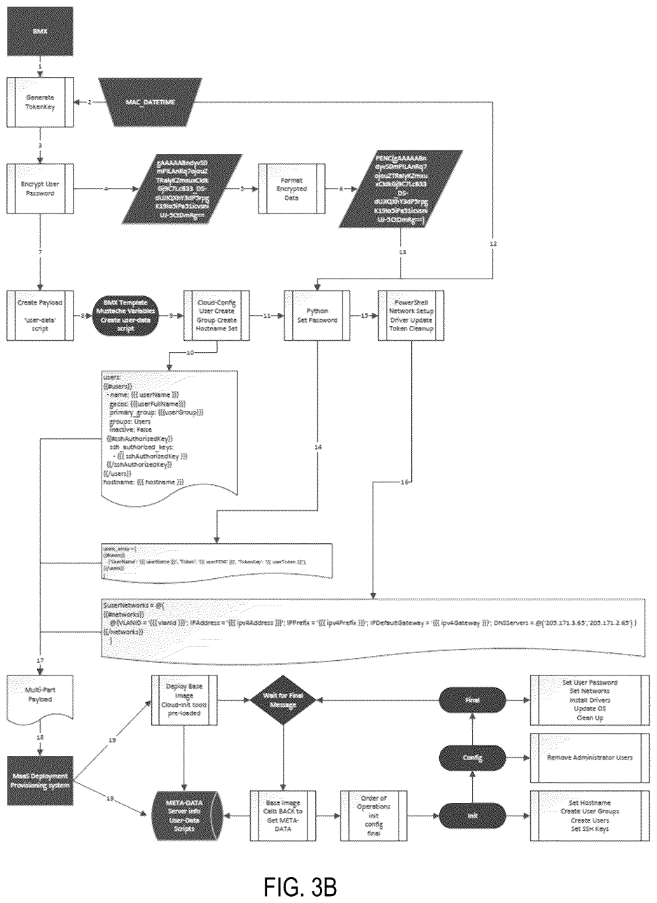

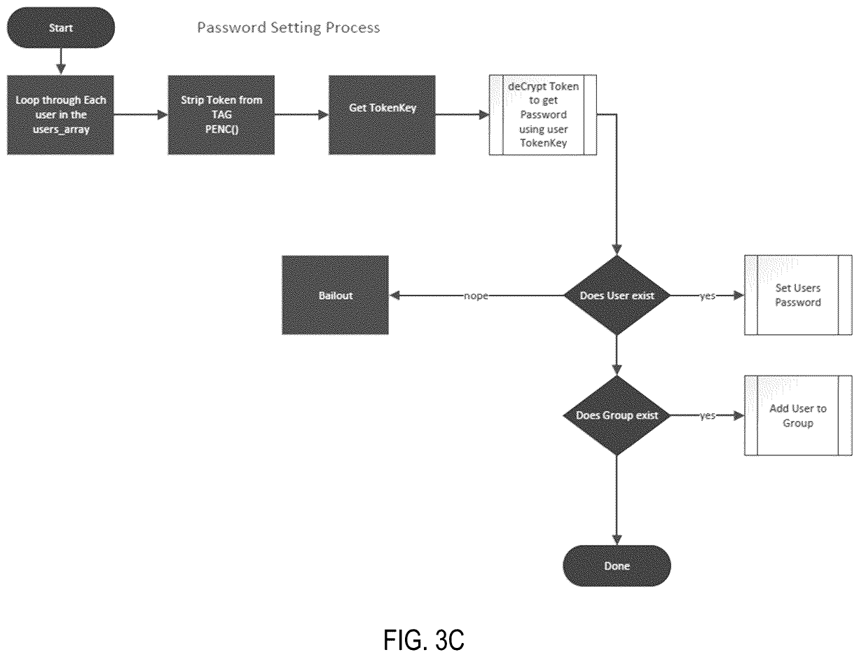

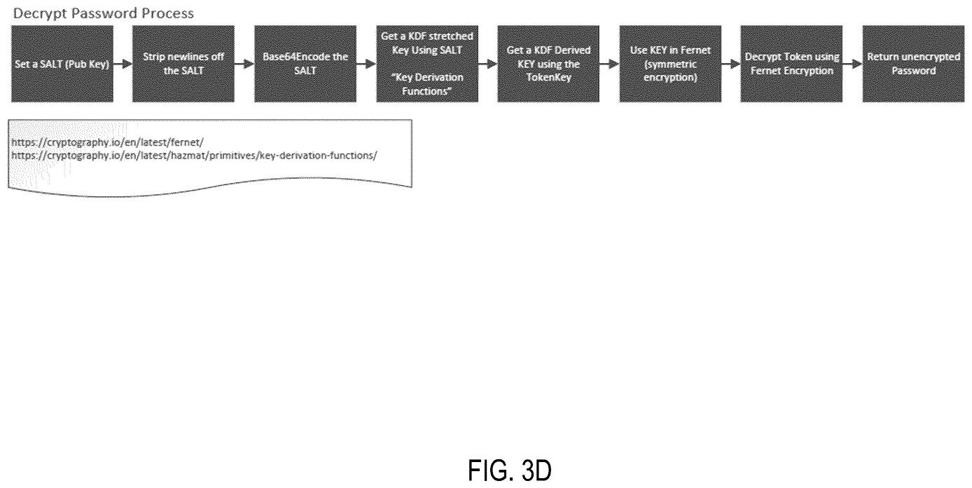

Turning to FIGS. 3A-3D, depicted are non-limiting example embodiments for the disclosed password management framework. As discussed herein, the disclosed framework, embodied as engine 200, as discussed below with reference to the steps of Process 300, operates/functions as an innovative solution for secure login mechanisms to network and local resources and devices.

As discussed herein, the framework provides a robust solution for managing Windows user passwords in cloud environments where traditional password management methods face limitations, particularly addressing the challenge of securely handling passwords that must be transmitted in cleartext format.

In some embodiments, the framework can securely manage Windows user passwords through a multi-stage process that leverages cloudbase-init's execution order and multi-part MIME capabilities. In some embodiments, the framework can implement encryption mechanisms using Python's Fernet encryption, combined with PBKDF2HMAC key derivation for enhanced security. This approach ensures that passwords remain protected throughout the transmission and deployment process.

In some embodiments, the framework utilizes a specialized encryption format called PENC (Password ENcoded) that encapsulates encrypted content within parentheses following the PENC identifier. This standardized format allows for easy identification and processing of encrypted passwords within configuration files and scripts.

In some embodiments, such encryption key generation mechanisms can employ a unique approach, combining the system's MAC address with the provisioning timestamp in YYYYMMDDHH format. Such temporal-hardware binding creates a unique encryption context for each deployment, significantly enhancing security by ensuring that encryption keys cannot be reused across different systems or time periods.

In some embodiments, the framework executes its password management through a carefully orchestrated three-stage process utilizing cloudbase-init's multi-part MIME capabilities:

Initial Configuration Stage: Handles basic system setup, including hostname configuration and user account creation. This stage establishes the foundational system structure without handling sensitive password data.

Password Management Stage: Executes the Python-based password management components, processing encrypted passwords and applying them to the appropriate user accounts. This stage leverages the encryption system to securely decrypt and apply passwords.

System Configuration Stage: Completes the deployment by handling network configuration, driver installation, and security cleanup processes. This stage ensures that all sensitive deployment data is properly sanitized from system logs.

In some embodiments, the framework implements comprehensive security measures throughout the deployment process: i) advanced encryption utilizing Fernet with PBKDF2HMAC key derivation; ii) time-based encryption keys that bind deployments to specific temporal window; iii) hardware binding through MAC address integration; iv) automated log sanitization to remove sensitive deployment data; and v) code obfuscation using base64 encoding for additional security.

In some embodiments, the framework seamlessly integrates with “mustache” templating systems, enabling dynamic user configuration while maintaining security. This integration allows for flexible deployment configurations while ensuring that password security measures remain intact throughout the templating process.

In some embodiments, post-deployment security can be maintained through automated log sanitization. The framework systematically removes sensitive information from system logs, replacing encrypted passwords with standardized placeholders and removing encryption keys. This ensures that no sensitive data persists in system logs after deployment completion.

Accordingly, in some embodiments, the framework's architecture allows for several potential enhancements: implementation of dynamic encryption key rotation; integration with hardware security modules for enhanced key protection; extended audit logging capabilities for security compliance; group-based password policy management; external key management system integration; enhanced encryption algorithm support, and the like.

Thus, as discussed herein, the disclosed framework represents a comprehensive technical solution for secure password management in Windows cloud environments. The framework effectively addresses the specific challenges of cloudbase-init's password handling requirements while maintaining robust security throughout the deployment process. Moreover, as evidenced from instant disclosure, the disclosed framework can be used for any type and/or format of sensitive data and/or metadata, whether known or known, without departing from the scope of disclosed systems and methods.

Turning to FIG. 3A, according to some embodiments, Step 302 of Process 300 can be performed by identification module 202 of management engine 200; Step 304 can be performed by analysis module 204; Step 306 can be performed by determination module 206; and Steps 308 and 310 can be performed by output module 206.

According to some embodiments, Process 300 begins with Step 302 where engine 200 can operate to identify a request for a secure password and/or provisioning of a device and/or account (Step 302). This process is initiated when a system requires secure credential management during deployment, particularly in environments where security vulnerabilities in password transmission need to be mitigated. In traditional Windows provisioning, passwords are often transmitted in cleartext, creating a critical security risk, especially in cloud-based or enterprise environments where multiple systems are deployed across different geographic locations. To address this issue, the disclosed framework ensures that password handling remains encrypted and protected throughout the provisioning lifecycle.

Upon receiving the request, the framework analyzes relevant data, including device specifications, user credentials, and account details (Step 304). This analysis encompasses various factors, such as the device's MAC address, deployment context, user roles, and authentication requirements. By leveraging a structured approach to data analysis, the framework ensures that password generation aligns with security policies while maintaining compatibility with existing infrastructure. The data analysis phase also determines whether the provisioning request is for a new user account, a device configuration update, or an integration with an existing system. Such information informs subsequent steps in the process, ensuring that the generated credentials meet specific deployment needs.

Using the analyzed data, the framework determines a secure password (Step 306). Unlike traditional password assignment methodologies that rely on predefined values or human input, this framework utilizes a novel encryption-based approach. Specifically, it generates unique encryption keys through a hybrid method that combines temporal and hardware-specific parameters. The primary key generation mechanism incorporates two essential elements: the epoch timestamp at the precise moment of provisioning and the unique MAC address of the target system. This hybrid approach ensures cryptographic uniqueness, even in scenarios where multiple deployments occur simultaneously. The hardware component (MAC address) guarantees differentiation across systems, while the temporal component (epoch timestamp) adds an additional layer of uniqueness and traceability.

To further enhance security, the framework can implement a key derivation process. It begins by concatenating the epoch timestamp and MAC address to form an initial seed for encryption. This seed undergoes multiple rounds of hashing, including the application of a predefined salt value. While the salt itself is technically public, it is obfuscated within the implementation to prevent trivial analysis of the key derivation process. This layered approach ensures that the generated encryption key remains secure and resistant to reverse engineering attempts. The resulting encryption key serves as the foundation for all subsequent password generation and encryption operations within the deployment workflow.

According to some embodiments, once a secure password is determined, the framework compiles and implements the password (Step 308). In some embodiments, such operations can involve encrypting the generated password using an advanced 256-bit public key encryption system with n (e.g., a threshold satisfying number of iterations—for example, 48,000) iterations of padding. In some embodiments, the padding mechanism ensures that even minimal password inputs are substantially expanded before encryption, effectively normalizing the encrypted output regardless of the input length. Such normalization process maintains consistent security levels across varying password complexities while ensuring that the final encrypted value remains compatible with existing authentication infrastructures. Depending on deployment requirements, the framework can then compress the encrypted values into either 512-bit or 256-bit hashes, optimizing storage efficiency while preserving cryptographic strength.

To ensure secure transmission and storage of the encrypted password, the framework utilizes a token generation system. In some embodiments, the framework creates encrypted password tokens encapsulating the actual credential values while preserving the security properties established during key generation. The token generation process includes multiple stages of transformation and validation, ensuring that each token can only be decrypted using the specifically generated key for that deployment instance. By incorporating a one-time-use encryption channel for each deployment, this approach prevents unauthorized access to password data and ensures that each provisioning process operates within an isolated security context.

As part of the implementation phase, the framework can provision the device (Step 310), integrating seamlessly with existing Windows system management tools. This integration is achieved through a staged execution process that maintains security throughout the deployment lifecycle. After the initial user creation phase, the framework executes a series of commands through native Windows interfaces (such as the ‘net user’ command) to apply the decrypted passwords. Importantly, decrypted passwords are only held in memory during the actual password-setting operation, minimizing exposure to potential security breaches. This ensures that sensitive credentials are never stored in plaintext within configuration files or logs, thereby mitigating the risk of unauthorized access.

Turning to FIGS. 3B-3D, depicted are work flows that provide depicts of non-limiting example embodiments as tied to the steps of FIG. 3A. For example, FIG. 3B provides an overall flow for provisioning a device, according to some embodiments; FIG. 3C provides an example work flow for a password setting process, according to some embodiments; and FIG. 3D provides an example work flow for a decrypt password process.

Beyond password management, the framework enhances overall system security by modifying the standard OOBE. It does so by preemptively configuring user accounts and removing default administrator credentials before the framework completes its initialization process. This proactive security measure eliminates the traditional unsecured setup period, ensuring that all provisioned systems are protected from first boot. The framework accomplishes this by executing its configuration steps before the standard Windows initialization sequence, effectively bypassing traditional user setup workflows while maintaining the integrity of credential data.

In some embodiments, the framework's configuration can enable support for hybrid environments, allowing it to function seamlessly across both Windows and Linux systems. While the core innovation addresses Windows-specific password handling vulnerabilities, its architecture permits parallel implementations in Linux environments. This cross-platform capability ensures that organizations deploying heterogeneous systems can maintain consistent security practices across all environments. In some embodiments, the framework achieves this by generating appropriate configuration files tailored to each operating system while adhering to a unified security model based on temporal-hardware key generation.

Furthermore, in some embodiments, the framework can integrate with existing cloud provisioning tools, particularly Cloud-base Init, enabling enhanced security within cloud-based deployments. By leveraging a modular approach, the encryption mechanism can be separated from broader configuration management functions, allowing third-party integrations through a public key infrastructure. Thus, deployment systems can incorporate their own public keys while still utilizing the framework's encryption methodology to secure password handling. This level of flexibility ensures that the framework can be adopted across various deployment scenarios while maintaining robust security measures.

To further fortify its security measures, the framework implements an obfuscation mechanism designed to protect salt values and encryption functions from analysis. This obfuscation extends to both encryption and decryption processes, ensuring that even if configuration files are exposed, the core security mechanisms remain protected. The obfuscation process includes multiple layers of code transformation and data encoding, making static analysis significantly more challenging while preserving the ability to execute required cryptographic operations.

Additionally, the framework can include token lifetime and validity management mechanisms. Since the encryption key incorporates an epoch timestamp, tokens generated during the provisioning process inherently carry a temporal context. This provides functionality for the potential implementation of expiration and validation mechanisms, ensuring that credentials remain valid only within a predefined timeframe. While the primary implementation focuses on securing immediate deployments, these expiration controls can be extended to provide enhanced security in scenarios requiring time-sensitive credential management.

In some embodiments, the framework also expands beyond traditional password management capabilities by addressing other limitations in current cloud provisioning systems. For example, it supports multi-network configuration capabilities that overcome the single-network constraints of Cloud Config and cloud-init implementations. This can be provided through the execution of multiple configuration scripts in different programming languages, such as Python, PowerShell, and standard Cloud Config. Each script is optimized for specific tasks while maintaining the security properties established by the encryption and token management functionality. By leveraging this multi-language approach, the framework ensures that all components of the deployment process remain secure, regardless of the underlying technology.

Overall, the disclosed framework provides a technical advancement in providing secure password handling and device provisioning. By addressing critical security vulnerabilities in Windows system provisioning, the framework eliminates the need for cleartext password transmission and enhances security across all deployment phases.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by an application executing on a computing system, information related to a provisioning event for a target device, the information comprising at least a timestamp corresponding to a time of the provisioning event and a hardware identifier associated with the target device;
analyzing, by the application, device specifications, user credentials, and account details associated with the provisioning event to determine deployment requirements;
applying, by the application, a salt value to the information to generate a seed value;
performing, by the application, multiple rounds of hashing on the seed value to derive an encryption key;
generating, by the application, based on the derived encryption key, a secure password for the target device, wherein the secure password is encrypted using a public key encryption system with iterations of padding;
creating, by the application, an encrypted password token encapsulating credential values related to the secure password;
decrypting, by the application, the encrypted password token using the derived encryption key during a password-setting operation, wherein a decrypted password is maintained only in memory during the password-setting operation; and
provisioning, by the application, the target device based on the decrypted password through a staged execution process.

2. The method of claim 1, wherein the padding mechanism normalizes encrypted output regardless of input length to maintain consistent security levels across varying password complexities.

3. The method of claim 1, wherein the staged execution process comprises:
an initial configuration stage that handles basic system setup including hostname configuration and user account creation without handling sensitive password data;
a password management stage that executes password management components to process the encrypted password token and apply the decrypted password to appropriate user accounts; and
a system configuration stage that completes deployment by handling network configuration and security cleanup processes.

4. The method of claim 3, wherein the security cleanup processes comprise:
systematically removing sensitive information from system logs by replacing encrypted passwords with standardized placeholders; and
removing encryption keys from the system logs to ensure no sensitive data persists in system logs after deployment completion.

5. The method of claim 1, wherein the encryption key derivation process comprises:
concatenating the timestamp and the hardware identifier to form an initial seed for encryption;
applying the salt value to the initial seed; and
performing key derivation operations to generate the encryption key, wherein the encryption key is resistant to brute-force attacks.

6. The method of claim 1, further comprising:
compressing encrypted values into a cryptographic hash to optimize storage efficiency while preserving cryptographic strength; and
validating the encrypted password token through multiple stages of transformation prior to decryption to ensure the encrypted password token can only be decrypted using the specifically generated key for the provisioning event.

7. The method of claim 1, wherein provisioning the target device further comprises:
preemptively configuring user accounts and removing default administrator credentials before a system initialization process completes; and
executing configuration steps before a standard initialization sequence to bypass traditional user setup workflows while maintaining integrity of credential data.

8. The method of claim 1, wherein the encrypted password token incorporates a temporal context based on the timestamp, and wherein the method further comprises:
implementing expiration controls that validate the encrypted password token only within a predefined timeframe; and
ensuring credentials remain valid only within the predefined timeframe.

9. The method of claim 1, further comprising:
implementing an obfuscation mechanism to protect the salt value and encryption functions from analysis, wherein the obfuscation mechanism comprises multiple layers of code transformation and data encoding applied to both encryption and decryption processes; and
preventing static analysis of configuration files while preserving ability to execute cryptographic operations required for provisioning the target device.

10. The method of claim 1, wherein the application operates in a cloud computing environment, and wherein the method further comprises:
generating multipart configurations to separate different execution stages of the provisioning event;
integrating with a templating system to enable dynamic user configuration while maintaining security measures; and
supporting cross-platform functionality across multiple operating systems while maintaining a unified security model based on temporal-hardware key generation combining the timestamp and the hardware identifier.

11. A non-transitory computer-readable storage medium tangibly encoded with computer-executable instructions that when executed by a computing system, perform a method comprising:
identifying, by an application executing on the computing system, information related to a provisioning event for a target device, the information comprising at least a timestamp corresponding to a time of the provisioning event and a hardware identifier associated with the target device;
analyzing, by the application, device specifications, user credentials, and account details associated with the provisioning event to determine deployment requirements;
applying, by the application, a salt value to the information to generate a seed value;
performing, by the application, multiple rounds of hashing on the seed value to derive an encryption key;
generating, by the application, based on the derived encryption key, a secure password for the target device, wherein the secure password is encrypted using a public key encryption system with iterations of padding;
creating, by the application, an encrypted password token encapsulating credential values related to the secure password;
decrypting, by the application, the encrypted password token using the derived encryption key during a password-setting operation, wherein a decrypted password is maintained only in memory during the password-setting operation; and
provisioning, by the application, the target device based on the decrypted password through a staged execution process.

12. The non-transitory computer-readable storage medium of claim 11, wherein the padding mechanism normalizes encrypted output regardless of input length to maintain consistent security levels across varying password complexities.

13. The non-transitory computer-readable storage medium of claim 11, wherein the staged execution process comprises:
an initial configuration stage that handles basic system setup including hostname configuration and user account creation without handling sensitive password data;
a password management stage that executes password management components to process the encrypted password token and apply the decrypted password to appropriate user accounts; and
a system configuration stage that completes deployment by handling network configuration and security cleanup processes, wherein the security cleanup processes comprise:
systematically removing sensitive information from system logs by replacing encrypted passwords with standardized placeholders; and
removing encryption keys from the system logs to ensure no sensitive data persists in system logs after deployment completion.

14. The non-transitory computer-readable storage medium of claim 11, wherein the encryption key derivation process comprises:
concatenating the timestamp and the hardware identifier to form an initial seed for encryption;
applying the salt value to the initial seed; and
performing key derivation operations to generate the encryption key, wherein the encryption key is resistant to brute-force attacks.

15. The non-transitory computer-readable storage medium of claim 11, further comprising:
compressing encrypted values into a cryptographic hash to optimize storage efficiency while preserving cryptographic strength; and
validating the encrypted password token through multiple stages of transformation prior to decryption to ensure the encrypted password token can only be decrypted using the specifically generated key for the provisioning event.

16. The non-transitory computer-readable storage medium of claim 11, wherein provisioning the target device further comprises:
preemptively configuring user accounts and removing default administrator credentials before a system initialization process completes; and
executing configuration steps before a standard initialization sequence to bypass traditional user setup workflows while maintaining integrity of credential data.

17. The non-transitory computer-readable storage medium of claim 11, wherein the encrypted password token incorporates a temporal context based on the timestamp, and wherein the method further comprises:
implementing expiration controls that validate the encrypted password token only within a predefined timeframe; and
ensuring credentials remain valid only within the predefined timeframe.

18. The non-transitory computer-readable storage medium of claim 11, further comprising:
implementing an obfuscation mechanism to protect the salt value and encryption functions from analysis, wherein the obfuscation mechanism comprises multiple layers of code transformation and data encoding applied to both encryption and decryption processes; and
preventing static analysis of configuration files while preserving ability to execute cryptographic operations required for provisioning the target device.

19. The non-transitory computer-readable storage medium of claim 11, wherein the application operates in a cloud computing environment, and wherein the method further comprises:
generating multipart configurations to separate different execution stages of the provisioning event;
integrating with a templating system to enable dynamic user configuration while maintaining security measures; and
supporting cross-platform functionality across multiple operating systems while maintaining a unified security model based on temporal-hardware key generation combining the timestamp and the hardware identifier.

20. A device comprising:
a processor configured to:
identify, by an application, information related to a provisioning event for a target device, the information comprising at least a timestamp corresponding to a time of the provisioning event and a hardware identifier associated with the target device;
analyze, by the application, device specifications, user credentials, and account details associated with the provisioning event to determine deployment requirements;
apply, by the application, a salt value to the information to generate a seed value;
perform, by the application, multiple rounds of hashing on the seed value to derive an encryption key;
generate, by the application, based on the derived encryption key, a secure password for the target device, wherein the secure password is encrypted using a public key encryption system with iterations of padding;
create, by the application, an encrypted password token encapsulating credential values related to the secure password;
decrypt, by the application, the encrypted password token using the derived encryption key during a password-setting operation, wherein a decrypted password is maintained only in memory during the password-setting operation; and
provision, by the application, the target device based on the decrypted password through a staged execution process.
